(19) United States
(12) Patent Application Publication
(10) Pub. No.: US 2008/0192651 A1
(43) Pub. Date: Aug. 14, 2008

(54) NETWORK CHECK USING ROUTING DATABASE

(75) Inventor: Christopher J. Gibbings, Westminster, CO (US)

Correspondence Address: HENSLEY KIM & HOLZER, LLC, 1660 LINCOLN STREET, SUITE 3000, DENVER, CO, 80264, US

(73) Assignee: Level 3 Communications, LLC, Broomfield, CO (US)

(21) Appl. No.: 12/027,464

(22) Filed: Feb. 7, 2008

Related U.S. Application Data
(60) Provisional application No. 60/889,132, filed on Feb. 9, 2007.

(51) Int. Cl. H04L 12/28

(52) U.S. Cl. 370/254

(57) ABSTRACT

A system can check links of a plurality of networks that use different routing protocols. The system derives link states from a copy of a routing database according to the format of the routing database. The derived link states are formatted into a reference format and compared to reference link states to determine link state differences. A reference link state file can be updated based on the determined link state differences. A method involves obtaining a copy of a routing database from a router and deriving current link states from the copy of the routing database according to the format of the routing database. The derived link states are formatted into a reference format. The current link states are compared to reference link states to determine link state differences. User-friendly router names and router interface names are obtained from, for example, a router configuration file. IP addresses in the link state differences are mapped to the router names and router interface names. The link state differences can then be presented in a user friendly presentation to the user including router names and router interface names.

### CROSS-REFERENCE TO RELATED APPLICATIONS

This patent application claims the benefit of U.S. Provisional Application Ser. No. 60/889,132, filed Feb. 9, 2007, and entitled “Network Check Using Routing Database”, which is hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2007 Level 3 Communications, LLC.

### TECHNICAL FIELD

Embodiments of the present invention generally relate to network communications. More specifically, embodiments relate to a network check using a routing database.

### BACKGROUND

In the field of network communications, a network includes numerous routers, switches or other devices for communicating across the network. The configuration of such devices is referred to as the topology. Network topologies change constantly as devices and device connections are added or removed, or become available or unavailable. It is important that network service providers be aware of the topology at any given time in order to provide the best service. Due to the complexity of network topologies, determining the topology can be a very complicated task. In addition, once the topology is determined, it is important that the network service provider be able to distinguish between problematic topology changes and legitimate topology changes.

Existing network analysis tools develop a map of the topology. Typically these tools determine network topology in real time, such that the map of the network topology is constantly updated as the topology changes. Such tools can make it difficult to identify the topology at any particular point in time and allow for a static analysis of the topology at a particular selected point in time.

In addition, existing network analysis tools typically run on devices that participate in the routing protocol of the network. As such, conventional network analysis tools must not only receive the routing information from a router, but also send the router topology information. The routing information that is sent is a sort of bogus routing table that, if done correctly, indicates to the router that the link to the network analysis device is not a valid link to send data packets over. However, there is the risk that the network analysis device could fail and send the router a routing table that indicates to the router that the link to the network analysis device is actually a valid link. Of course, such a failure scenario could lead to routers sending data to the network analysis tool, resulting in their non-delivery to the proper recipient.

The foregoing and other problems are addressed by embodiments of the present invention.

### SUMMARY

Embodiments of the present invention relate to systems and methods for checking network link states using a routing database. A system for checking link states does not need to participate in the routing protocol, whereby routing tables are automatically shared among routers. As such, router overhead processing can be reduced from that of conventional approaches, and there is no risk of the network check system erroneously sending an invalid routing update to a router.

Embodiments of a system can check link states of a plurality of networks that use different routing protocols. The system logs into a router and requests a copy of the routing database. The system derives link state from the copy of the routing database according to the format of the routing database. Formats of routing databases include OSPF, IS-IS, and variations, such as variations including traffic engineering data. The derived link states are formatted into a reference format. The link states in the reference format are compared to a link state reference file to determine differences between the current link states and the link states of the reference file. The reference file may include link states of the same network at a prior time, or other reference link states. The reference link state file can be updated based on the determined link state differences.

An embodiment of a method involves obtaining a copy of a routing database from a router and deriving current link states from the copy of the routing database according to the format of the routing database. The derived link states are formatted into a reference format. The current link states are compared to reference link states to determine link state differences. User-friendly router names and router interface names are obtained from, for example, a router configuration file. IP addresses in the link state differences are mapped to the router names and router interface names. The link state differences can then be presented in a user friendly presentation to the user including router names and router interface names.

An embodiment of a method for determining changes in network topology includes obtaining a copy of a routing database from a router in a network, deriving current link states from the copy of the routing database according to a routing database format associated with the routing protocol used on the network, formatting the current link states into a reference format, and comparing the formatted current link states to reference link states to determine differences between the current link states and the reference link states. Obtaining a copy of the routing database may include logging in to the router and requesting routing database from the router. Obtaining a copy of the routing database may include requesting the routing database through a management connection to the router. Obtaining a copy of the routing database comprises receiving the copy of the routing database by a computer that does not participate in the routing protocol.

The method may further include obtaining router interface names identifying router interfaces associated with one or more routers on the network. The method may still further include mapping Internet Protocol addresses of router interfaces in the routing database with associated ones of the router interface names. The method may further yet include presenting the determined link state differences in a user-friendly presentation including the router interface names. The reference link states may be prior network link states.

Further still, the method may include updating the reference link states based on the determined link state differences. The method may further include receiving input from a user indicating one or more link state changes that are permanent.

An embodiment of a system for determining changes in a network topology includes a link state capture module configured to obtain a copy of a routing database from a connected router, a link state derivation module configured to derive current link states from the copy of the routing database according to a routing protocol database format associated with a routing protocol used by the router, a formatting module configured to format the derived current link states into a reference format, and a comparing module configured to compare the current link states to reference link states to determine one or more link state differences. The system may further include a names determination module configured to obtain router interface names and map the router names to IP addresses in the link state differences. The system may further include a user input processing module operable to receive input from a user indicating one or more link state changes that should be permanent.

In one embodiment, the link state capture module obtains a copy of the routing database by logging in to the network router via a management connection to the network router. In this or other embodiments, the link state capture module does not participate in the routing protocol with the network router. The system may further include an output module configured to present the link state differences in a user-friendly presentation including the mapped router interface names. The user-friendly presentation can present link state differences on a link-by-link basis. The link by link presentation names both network routers on either end of a fink and both router interfaces on either end of the link. The link state differences that are presented may include removed links, added links, changed metrics, changed bandwidth, changed router identifier, and changed color.

Embodiments of the system may further include a reference link state update module configured to use the link state differences to update the reference link states to correspond to the current link states. The system of claim 11, further comprising a reference link state update module configured to update the reference link states with changes that a user marks as permanent. The routing protocols include an Open Shortest Path First (OSPF) routing protocol, an OSPF protocol with Traffic Engineering (TE) extensions, and intermediate system to intermediate system (IS-IS) protocol.

### BRIEF DESCRIPTION OF THE DRAWINGS

FIG. 1 illustrates an operating environment suitable for practicing embodiments of the present invention.

FIG. 2 illustrates an embodiment of a system for practicing network checking using a routing database.

FIG. 3 illustrates an embodiment of an algorithm for practicing network checking using a routing database.

FIG. 4 illustrates a general purpose computing device upon which one or more aspects of embodiments may be implemented.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Embodiments of the present invention relate to systems and methods for checking network link states using a routing database. A system for checking link states does not need to participate in the routing protocol, whereby routing tables are automatically shared among routers. As such, router overhead processing can be reduced from that of conventional approaches, and there is no risk of the network check system erroneously sending an invalid router table to a router.

Embodiments of a system can check link states of a plurality of networks that use different routing protocols. The system logs into a router and requests a copy of the routing database. The system derives link state from the copy of the routing database according to the format of the routing database. Formats of routing databases include OSPF, IS-IS, and variations, such as variations including traffic engineering data. The derived link states are formatted into a reference format. The link states in the reference format are compared to a link state reference file to determine differences between the current link states and the link states of the reference file. The reference file may include link states of the same network at a prior time, or other reference link states. The reference link state file can be updated based on the determined link state differences.

An embodiment of a method involves obtaining a copy of a routing database from a router and deriving current link states from the copy of the routing database according to the format of the routing database. The derived link states are formatted into a reference format. The current link states are compared to reference link states to determine link state differences. User-friendly router names and router interface names are obtained from, for example, a router configuration file. IP addresses in the link state differences are mapped to the router names and router interface names. The link state differences can then be presented in a user friendly manner to the user.

Prior to describing one or more preferred embodiments of the present invention, definitions of some terms used throughout the description are presented.

### Definitions

A “module” is a self-contained functional component. A module may be implemented in hardware, software, firmware, or any combination thereof.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The terms “responsive” and “in response to” includes completely or partially responsive.

The term “computer-readable media” is media that a computer is capable of reading, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

### Exemplary System

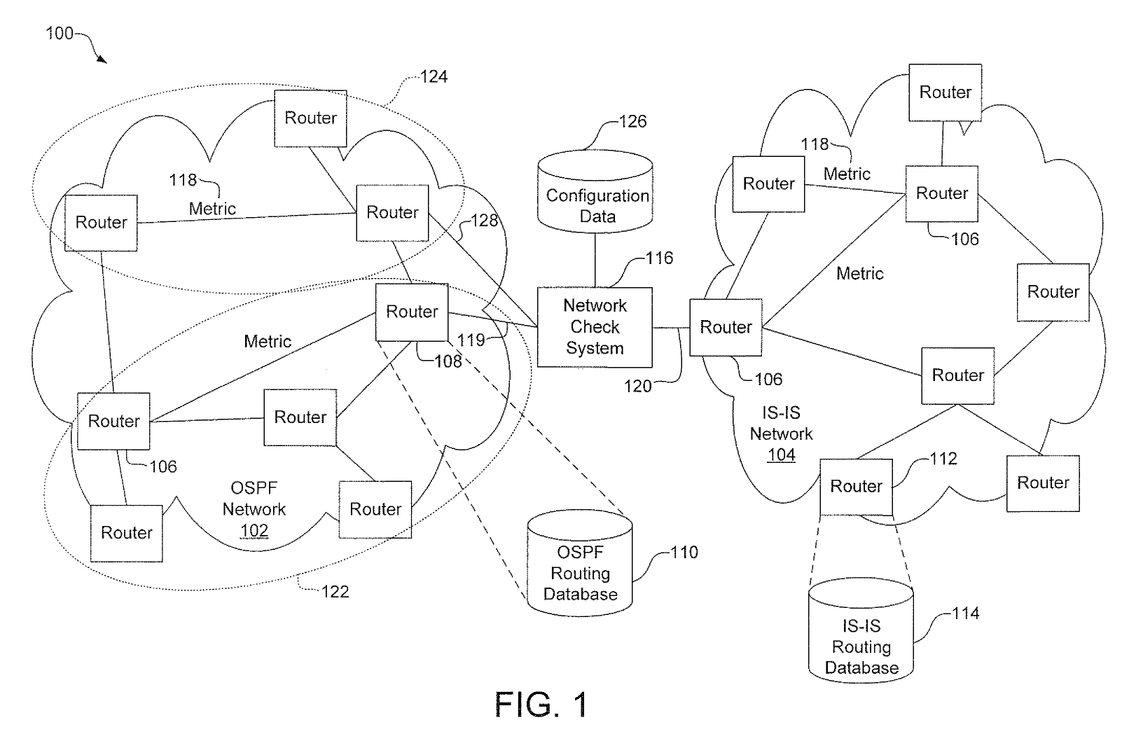

FIG. 1 illustrates an exemplary network environment 100 where network checking using one or more router databases can be practiced. The network environment 100 includes a first network 102 and a second network 104. Each Different routing protocols are used on the first network 102 and the second network 104. To illustrate, network 102 may utilize Open Shortest Path First (OSPF) routing protocol and network 104 may utilize Intermediate System to Intermediate System (IS-IS) routing protocol. Other routing protocols and variations thereof may be used. For example, traffic engineering (TE) may be used in conjunction with OSPF or IS-IS. The networks may be in any type, such as, but not limited to, backbone networks, edge networks, Points of Presence (POPs), local area networks (LANs), wide area networks (WANs), and so on.

Both networks include multiple nodes, such as routers 106 for forwarding data packets through the networks. Routers 106 forward data packets from router 106 to router 106 to send data packets from their source to their destination. Each of the routers 106 includes a database including a variety of information about network topology, router settings, and so on. Typically, the data included in, and the format of, the router databases differs depending on the routing protocol used. Thus, for example, a router 108 in the OSFP network 102 has an OSPF routing database 110 and a router 112 in the IS-IS network 104 has an IS-IS routing database 114. Generally, routers 106 can be configured to carry out different routing protocols, depending on the network they are part of.

Details of the routing database 110 and 114 are more fully discussed below. A network check module 116 is operable to take snapshots (i.e., get copies) of the routing databases 106 and use the information from the routing database 106 to determine changes in link states compared to reference link states or changes in link states over time. The network check system 116 includes functionality to take snapshots of different routing protocol databases and analyze different routing protocol databases to determine differences between reference link states or prior link states.

In this embodiment, in general, the OSPF routing database 110 and IS-IS routing database 114 each include a full routing table, although in different formats. A full routing table includes data obtained from the sharing of routing tables with other routers during a routing protocol process, as well as other data acquired during other processes or configured onto the router 106. For example, the OSPF routing database 110 and the IS-IS routing database 114 each generally include a table of route identifiers, next hops, metrics, and quality of service, as well as border gateway protocol (BGP) data, statically configured routes, and connected interface data. The particular details and format of the router data typically differs between the OSPF routing database 110 and the IS-IS routing database. The routing database may also including traffic engineering (TE) data, which can include other information, such as, but not limited to bandwidth and link color.

Routers 106 use the routing database information to determine where data packets should be routed to next. Typically the “best” route is chosen by the router 106 when forwarding data packets. Metrics 118 are costs associated with the links between routers 104. Typically a metric 118 is a numerical value, where the higher the number, the greater the cost. The link selected by the router 106 to forward a data packet over depends at least in part on the metrics 118 associated with the different links connected to the router 106.

The topologies of the first network 102 and the second network 104 change over time. Routers 106 may be added or removed. Links may be added or removed. Links may fail or come back into service. Metrics 118 may change, for example when link status changes. A link failure, for example, is reflected by an increase in the corresponding metric 118 to a very large value. It is important for network administrators and service providers to be able to check for changes in the network topology and in particular link state. For example, administrators would like to be able to quickly determine the status of links in the network, and be able to determine the link status has changed, and why it might have changed.

As mentioned above, the network check system 116 provides network checking capability, whereby link state changes can be identified. Users of the network check system 116 are presented link state differences in a user friendly manner. Link state differences can correspond to changes to the network topology at different points in time. In some embodiments, the network check system 116 determines differences between the current network topology and a reference network topology, which may not necessarily be a prior network topology, but some relevant reference topology. The network check system 108 can present link state changes to the user in a user-friendly presentation, for example, including router names and router interface names, rather than, or in addition to IP addresses. For example, in an OSPF context with traffic engineering, the network check system 108 could present the following:

| New Link | Metric | Bandwidth | Color |
|---|---|---|---|
| A-router~so-0/3/0.0 <-> A-route~so-1/0/0.0 | 4222 | 9.9533G | None |

As discussed, a routing protocol is used on each of the networks. The routing protocol is a process by which routers 106 exchange routing information with each other so that each router 106 has a snapshot of the network topology. By periodically exchanging routing information, routers 106 can update their routing tables with the most recent state of links in the network that they are a part of.

In some conventional network topology analysis systems, a network analyzer actually participates in the routing protocol, and actually mimics a router in order to obtain the routing table from the router. Unlike these conventional network topology analysis systems, embodiments of the network check system 116 do not participate in the routing protocol with the routers 106. In this regard, the network check system 116 is not configured on a port of the router 106 to which it is connected. Therefore, the router 106 does not periodically automatically send its routing table to the network check system 116, as it does with other routers 106 within its network; nor does the network check system 116 send a routing table to the connected router 106. In conventional systems, the network topology analysis system is configured on a port of the attached router and must send the router some topology information, albeit minimalist.

Existing network analysis tools typically run on devices that participate in the routing protocol of the network, but may be physically remote from some network domains (e.g. OSPF areas). To participate in routing in this network domain a tunnel would typically be configured to a network in that domain, being routed through other domains to get there. In periods of severe network disruption in other parts of the network the tunnel connectivity may be lost and the device will lose information about the remote domain. In contrast, management networks are usually designed to be independent of the main routing network protocol. Therefore it should generally be possible to obtain snapshot copies of the routing protocol database even though other routing domains are being disrupted.

The network check system 116 is connected to a management interface of a connected router 106 via a management link. For example, in FIG. 1, the network check system 116 is connected to a router 106 in the OSPF network 102 by management link 119 and another router 106 in the IS-IS network 104 by another management link 120. Because the network check system 116 is not configured on a port of the connected routers 106, there is much less overhead imposed on the routing protocol processes of the connected routers 106 than in conventional arrangements.

The network check system 116 sends commands, such as via Telnet, at times dictated by an administrator. For example, the administrator 108 may send a command for the connected router 106 to send a copy of the routing database 110 or routing database 114 when there is tremendous network congestion reported on the OSPF network 102 or the IS-IS network 104, respectively. The administrator 116 may also request the routing table(s) on a regular basis (e.g., once per week) to determine changes on a regular basis.

In some embodiments, the network check system 116 is connected to more than one router 106 in a single network. For example, the network check system 116 is connected to two routers 106 in the OSPF network 102: a first router 108 in a first OSPF area 122 and a second router 106 in a second OSPF area 124. Like the management link 119, the network check system 116 is connected to the router 106 in the second OSPF area 124 by another management link 128.

The network check system 116 may use a source of configuration data 126 that provides router configuration data. Included in the router configuration data are router names, router interface names, and associated IP addresses. The configuration data 126 may comprise a database and/or a server computer that stores and periodically updates router configuration data. The router configuration data 126 can be used by the network check system 116 to map IP addresses found in the routing database 110 and 114 to router names/router interface names. The router names and interface names are generally more user friendly than, for example, IP addresses; i.e., the router names and interface names are more readily recognizable and understandable by a human user. The network check system 116 presents link state changes using router names and interface names for a more user-friendly presentation.

The network check system 116 may be implemented in any general purpose or special purpose computing device. By way of example, but without limitation, the network check system 116 may be implemented in a server computer, a laptop computer, a desktop computer, or other. In some embodiments, the network check system 116 is remote to the connected router(s) 106. For example, the network check system 116 could be deployed at a network operations center (NOC). However, there is no limitation as to the geographic location of the network check system 116 relative to the connected routers 106.

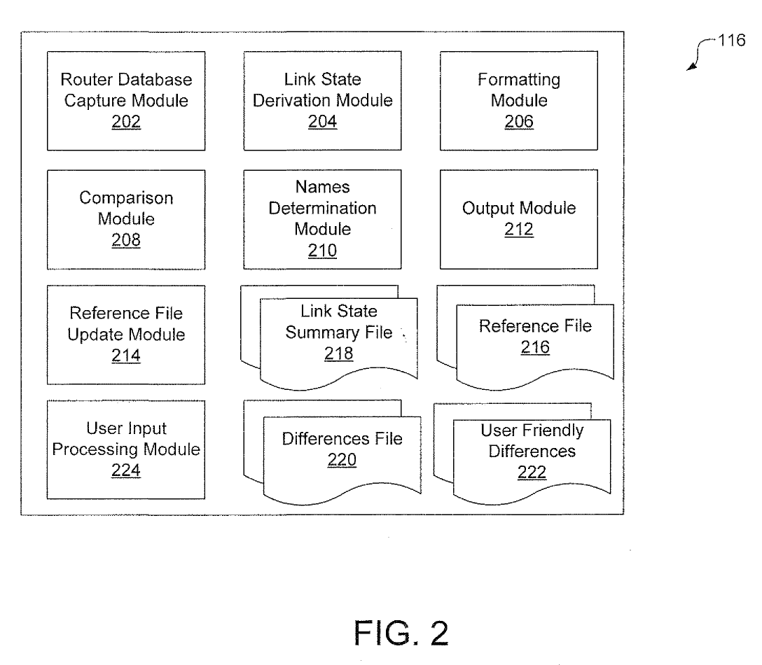

FIG. 2 illustrates an embodiment of a network check system 116. The network check system 116 includes a number of functional modules, such as a router database capture module 202, a link state derivation module 204, a formatting module 206, a comparison module 208, a names determination module 210, an output module 212, a reference file update module 214 and a user input processing module 224. The network check system 116 also includes one or more link state reference files 216, and generates one or more current link state summary files 218, one or more link state difference files 220, and one or more user-friendly differences files 222.

The router database capture module 202 obtains a copy of a router database. In one embodiment, the router database capture module 202 runs a script that causes the network check system 116 to log into a connected router and send one or more commands to the router. The command(s) cause the router to send the network check system 116 a copy of the router database. An exemplary command and response are shown here for an OSPF routing database:

Example OSPF Command: ROUTER2> show ospf database area 0.0.0.7 router extensive

Example OSPF Response: OSPF link state database, Area 0.0.0.7 Type ID Adv Rtr Seq Age Opt Cksum Len Router 1.1.1.1 1.1.1.1 0x80009181 1301 0x22 0x2063 144 bits 0x2, link count 10 id 2.2.2.2, data 21.0.02, Type PointToPoint (1) TOS count 0, TOS 0 metric 20id 21.0.0.0, data 255.255.255.252, Type Stub (3) TOS count 0, TOS 0 metric 20id 3.3.3.3, data 31.0.0.0, data 255.255.255.252, Type Stub (3) TOS count 0, TOS 0 metric 50 id 1.1.1.1, data 255.255.255.255, Type Stub (3) TOS count 0, TOS 0 metric 1Aging timer 00:38:18 Installed 00:21:40 ago, expires in 00:38:19, sent 00:21:30 ago Last changed 7w0d 23:43:43 ago, Change count: 6Router *2.2.2.2 2.2.2.2 0x800lbc82 155 0x22 0x82de 72bits 0x1, link count 4id 1.1.1.1, data 21.0.0.1, Type PointToPoint (1) TOS count 0, TOS 0 metric 20id 21.0.0.0, data 255.255.255.252, Type Stub (3) TOS count 0, TOS 0 metric 20 id 2.2.2.2, data 255.255.255.255, Type Stub (3) TOS count 0, TOS 0 metric 1 Gen timer 00:27:24 Aging timer 00:57:24 Installed 00:02:35 ago, expires in 00:57:25, sent 00:02:33 ago Last changed 6w4d 22.43.55 ago, Change count: 9, Ours Router 3.3.3.3 3.3.3.3 0x800lba36 1574 0x22 0xa7f5 72 bits 0x1, link count 4id 1.1.1.1, data 31.0.0.1, Type PointToPoint (1) TOS count 0, TOS 0 metric 50id 31.0.0.0, data 255.255.255.252, Type Stub (3) TOS count 0, TOS 0 metric 50 id 3.3.3.3, data 255.255.255.255, Type Stub (3) TOS count 0, TOS 0 metric 1 Aging timer 00:33:45 Installed 00:26:12 ago, expires in 00:33:46, sent 00:26:11 ago Last changed 7w-d 23:36:05 ago, Change count: 7

Another exemplary command and response are shown below for an IS-IS routing database:

Example IS-IS Command: ROUTER2> show isis database detail

Example IS-IS Response:

ROUTER1.00-00 Sequence: 0x105f0, Checksum: 0xc487, Lifetime:
462 secs

| | | |
|---|---|---|
| IS neighbor: ROUTER2.00 | Metric: | 20 |
| IS neighbor: ROUTER3.00 | Metric: | 50 |
| IP prefix: 21.0.0.0/30 | Metric: | 20 Internal Up |
| IP prefix: 31.0.0.0/30 | Metric: | 50 Internal Up |
| IP prefix: 1.1.1.1/32 | Metric: | 10 Internal Up |

ROUTER2.00-00 Sequence: 0xf331, Checksum: 0x9b1c, Lifetime:
792 secs

| | | |
|---|---|---|
| IS neighbor: ROUTER1.00 | Metric: | 20 |
| IP prefix: 21.0.0.0/30 | Metric: | 20 Internal Up |
| IP prefix: 2.2.2.2/32 | Metric: | 10 Internal Up |

ROUTER3.00-00 Sequence: 0xd073, Checksum: 0x30da, Lifetime:
1087 secs

| | | |
|---|---|---|
| IS neighbor: ROUTER1.00 | Metric: | 50 |
| IP prefix: 31.0.0.0/30 | Metric: | 50 Internal Up |
| IP prefix: 3.3.3.3/32 | Metric: | 10 Internal Up |

In one embodiment, the router database capture module 202 includes multiple scripts or programs for the various routing protocols on the networks that are checked. For example, there may be a program for each of OSPF, IS-IS, OSPF with TE, IS-IS with TE, or others. The proper program is selected, depending on the network that is being checked. The router database capture module 202 may obtain copies of router databases from multiple routers in a single network. For example, the router database capture module 202 may obtain copies of router databases from routers in multiple OSPF areas of a network.

The link state derivation module 204 uses the copy of the routing database sent from the router to derive the link states of the network (or area of the network). In one embodiment, the link state derivation module 204 extracts link state information from the copy of the routing database. This may involve only extracting data that is relevant to the link states of all links within the network or network area. The link state derivation module 204 derives link state according to the format of the routing database. As discussed above, each routing protocol may have a different associated routing database format. As such, the link state derivation module 204 typically includes a link state derivation script or program for each of the routing protocol formats.

In one embodiment, in an OSPF protocol environment, the link state derivation module 204 uses the interface IP address as a unique key to extract the link state information. The OSPF metric is stored in, and retrieved from, the database on a per-interface-IP address basis. The link state derivation module 204 extracts the link IP address, A-end router ID, Z-end router ID, and OSPF metric, where A-end router ID is the ID of one of the routers on the link and the Z-end router is the ID of the other router on the link.

In an embodiment of the link state derivation module 204, in an IS-IS environment, the router name (IS-IS version) and IP network are used as the unique key. To be added as a link, an IP network on a point-to-point link must be present at both ends of a router-router link A-B, match IS-IS metric for router-router link on router A, and match IS-IS metric for router-router link on router B. To be added as a link, an IP network on broadcast LAN must have a matching metric match for the LAN and IP network on each router (e.g. router A must have metric X for both LAN and IP in database), and more than one router must satisfy the matching metric condition on the LAN.

The formatting module 206 receives the output link state data from the link state derivation module 204 and formats the link state data into a reference format that can be used for comparison later.

To illustrate, with reference to the example OSPF database data shown above, after the link state derivation module 204 and formatting module 206 have processed the OSPF database, the formatted link state data may be:

Example OSPF link states:

21.0.0.1, 2.2.2.2, 1.1.1.1, 20, ,
21.0.0.2, 1.1.1.1, 2.2.2.2, 20, ,
31.0.0.1, 3.3.3.3, 1.1.1.1, 50, ,
32.0.0.2, 1.1.1.1, 3.3.3.3, 50, ,

For the IS-IS database data shown above, the link state derivation module 204 and formatting module 206 may generate the following link states in a reference format:

Example IS-IS link states:

ROUTER1, 21.0.0.0/30, , 20,
ROUTER2, 21.0.0.0/30, , 20,
ROUTER1, 31.0.0.0/30, , 50,
ROUTER3, 31.0.0.0/30, , 50,

A current link state summary file 218 can be created for one or more of the routing protocols, networks or areas. The summary file 218 includes a complete list of the links, their current metrics, and, if TE is used, their current bandwidth and link color. The current link state files are in a reference format that can be used for comparison with the reference file(s) 216.

The comparison module 208 compares the links and associated link state data in the summary files 218 with the links and link states in the corresponding reference link state files 216. There is a reference file 216 for the OSPF network and another reference file 216 for the IS-IS network, and there may be other reference files 216 for other networks or network areas using different routing protocols. In general, the comparison module 208 searches for each link identified in the current link state summary file 218 in the reference link state file 216. If the current link is not found in the reference link state file, the current link is identified as a new/added link. If the current is found in the reference link state file, the link state parameters are compared for the link. Any links in the reference file 216 that are not in the current link state summary file 218 are identified as removed or deleted links.

To compare the OSPF links, the comparison module 208 selects the OSPF reference file 216 and compares the link states therein to the link states of the OSPF current link state summary file 218. The metric in each current link is compared with the metric of the corresponding link of the reference file (assuming the link is not an added link). The router with interface IP address will have an associated router ID. Point-to-point connections and /30 networks can be treated the same in reference file 216. For point-to-point connections or /30 network the reference file links are compared to the current link for router ID at the other end of the link. For other network connections (not /30) the reference links are compared to the current links for connected network and netmask.

To compare the IS-IS links, the comparison module 208 selects the IS-IS reference file and compares the link states therein to the link states of the IS-IS current link state summary file 218. Each link of the current link state is searched for in the reference link state file. If it's not found, the link is considered a new or added link. If the link is found in the reference link state file, the IS-IS link state parameters are compared. Links in the reference link state file that are not found in the current link state are identified as removed or deleted.

The comparison module 208 notes any differences in links between the respective link state files. Differences of note may be added links, removed links, changed metrics, added routers, removed routers, or others. When traffic engineering is used, other differences may be looked for and noted, such as changes in bandwidth and link color. The comparison module 208 generates one or more differences files 220 that include differences that are detected. There is typically a differences file 220 for each network or network area.

The names determination module 210 determines router names and interface names associated with routers in the network(s) and their interfaces. In one embodiment, the names determination module 210 accesses a router configuration database or server that stores and periodically updates router configuration data, including IP addresses, router names and router interface names.

The output module 212 formats the differences file(s) 220 for a user-friendly presentation and outputs the user-friendly differences in some output mode, for example, on the display screen, in a file, and/or on a print out. For example, the output module 212 may create user-friendly differences file(s) 222. In one embodiment, the link differences are presented to the user via a graphical user interface. Link state differences can be shown on a link-by-link basis. An example of a user-friendly presentation of link state differences is shown here:

| Metric Change | Reference | Current |
|---|---|---|
| A-router5~as2.0 → A-router54~as3.0 | 18500 | 18000 |
| A-router43~so-0/0/0.0 ←→ A-router22~so-1/0/0.0 | 11661 | 10570 |
| A-router11~as1.0 ←→ A-router10~as4.0 | 1487 | 60000 |

In the foregoing example output, the first two lines may correspond to ongoing metric changes, whereas the third line probably corresponds to an isolated link, and probably a fault, given the current metric of 60,000. In this particular example, the metric of 60,000 may correspond to a link that has been deliberately given a high metric to make sure traffic takes an alternative path. The metric may be set to such a high setting, for example, if the link drops a fraction of the IP packets passing through it due to a hardware fault.

With further reference to the exemplary user-friendly output shown above, a user, such as a network technician or administrator, will find such information beneficial for quickly identifying and fixing network problems. For example, the router names (e.g., A-router5, A-router54) in the output enable the user to login to the affected device and determine why someone has modified the metrics. Because there may be many interfaces on the router, the interface names (e.g., as2.0, as3.0) enable the user to quickly identify and correct the affected interface quickly. In addition there may be parallel links between two routers, and both links should have the same metric, but the metric on only one link has been reconfigured. Such a situation can be quickly identified using the router names and interface names.

The user input processing module 224 is operable to receive user input related to the link differences and process the input for use by other modules. In some embodiments, the user can select link state changes shown in the output presentation that are to be made permanent or not. For example, by using a mouse or other input device, the user can select one or more of the link state differences to be made permanent. The user input processing module 224 can responsively mark user-selected link state differences as being permanent or not, for example, in the link state differences file 220, or some other file, for use by the reference file update module 214.

The reference file update module 214 can update the link state reference file(s) with link state changes. For example, differences identified by the comparison module 208 may relate to changes in the network link states that are to be made permanent. It may be desirable to reflect such permanent changes in the link state reference file(s) 216. Of course, later comparisons would be with respect to the updated reference file(s) 216.

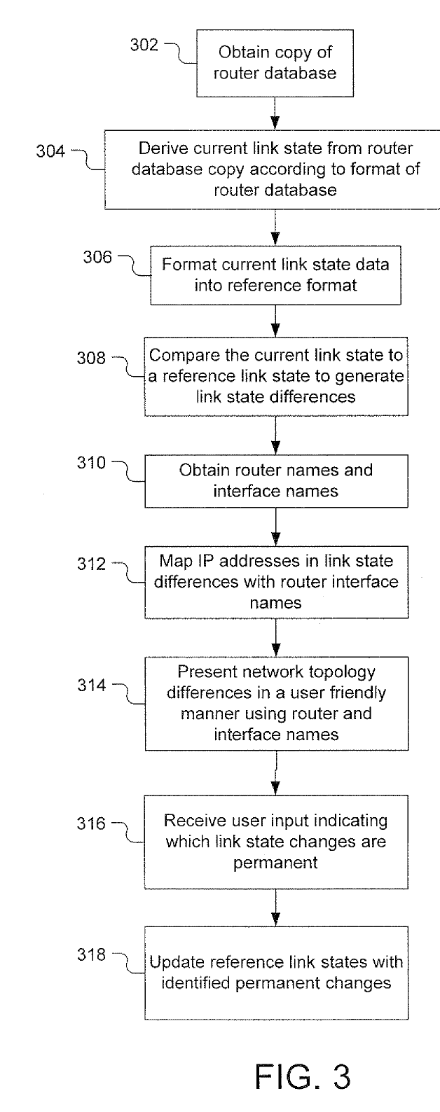

FIG. 3 is a flowchart illustrating an example algorithm 300 for checking for differences between current link states in a network and reference link states. The reference link states may be link states from a prior configuration of the network, or another set of reference link states. The algorithm may be carried out by a computing device executing computer-readable instructions (e.g., network check system 116, FIG. 1). For example, the computing device may execute one or more scripts or programs. The computing device is communicably coupled to one or more routers in a network.

In an obtaining operation 302, a current copy of the routing database is obtained from the connected router(s). In one embodiment, the obtaining operation 302 logs into the router(s) and sends a command to the router instructing the router to send the routing database. In a deriving operation 304, links and their corresponding link states are derived from the copy of the routing database. In one embodiment, the deriving operation 304 extracts links and link state parameters from the copy of the routing database according to a routing database format associated with the routing protocol.

In a formatting operation 306, the derived link state data is formatted into a reference format that allows for comparing current links to reference links. The formatting operation may store the current links and their link state parameters in a link state summary file. In a comparing operation 308, the current links and link states are compared to reference links and link states. The comparing operation 308 generally attempts to find each current link among the reference links. If the current link is found, the parameters of the link state are compared. If the current link is not found, the current link is considered a new or added link. Additionally, links that are in the reference fink states, but that are not in the current link states are considered removed links. Similarly, routers may be identified as added or removed. The comparing operation 308 yields link state differences.

In another obtaining operation 310, router names and router interface names are obtained. In one embodiment, a router configuration database is accessed to determine a set of IP addresses associated with router names and router interface names in the configuration file. In a mapping operation 312, the IP addresses in the link state differences are mapped to the router interface names. In some embodiments, the router names and router interface names are mapped to associated IP addresses in the copy of the routing database, the current link state summary, and/or the link state differences. In a presenting operation 314, the link state differences are presented in a user-friendly presentation including the router names and router interface names. In one embodiment the link state differences are presented on a link-by-link basis.

In a receiving operation 316, the system can receive input from the user identifying which of the link state changes are permanent or which link state changes are not permanent. For example, a link that is identified as removed may have been removed in error. Such a change in link state would not be marked as permanent by the user. However, a newly added router or link may be marked as permanent. As another example, changes in metrics, bandwidth or color may or may not be marked as permanent. In an updating operation 318, the reference link states are updated. In one embodiment, the updating operation 318 edits the reference link states file to include permanent changes identified by the user.

### Exemplary Computing Device

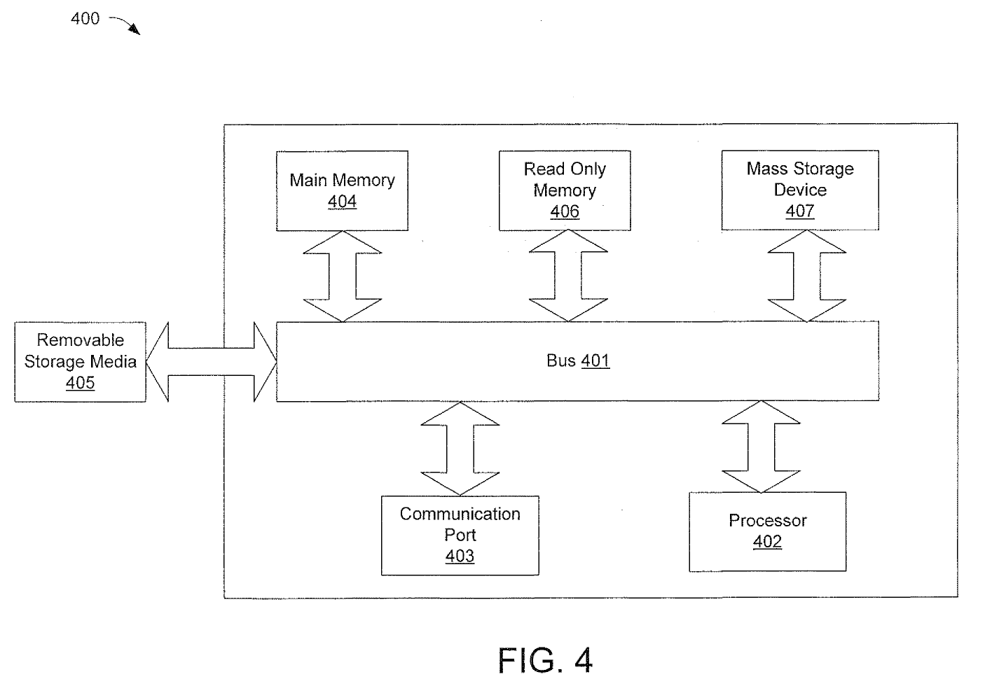

FIG. 4 is a schematic diagram of a computing device 400 upon which embodiments of the present invention may be implemented and carried out. As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware.

According to the present example, the computing device 400 includes a bus 401, at least one processor 402, at least one communication port 403, a main memory 404, a removable storage media 405, a read only memory 406, and a mass storage 407. Processor(s) 402 can be any know processor, such as, but not limited to, an Intel® Itanium® or Itanium 2® processor(s), AMD® Opteron® or Athlon MP® processor(s), or Motorola® lines of processors. Communication port(s) 403 can be any of an RS-232 port for use with a modem based dialup connection, a 10/100 Ethernet port, a Gigabit port using copper or fiber, or a USB port. Communication port(s) 403 may be chosen depending on a network such a Local Area Network (LAN), Wide Area Network (WAN), or any network to which the computing device 400 connects. The computing device 400 may be in communication with peripheral devices (not shown) such as, but not limited to, printers, speakers, cameras, microphones, or scanners.

Main memory 404 can be Random Access Memory (RAM), or any other dynamic storage device(s) commonly known in the art. Read only memory 406 can be any static storage device(s) such as Programmable Read Only Memory (PROM) chips for storing static information such as instructions for processor 402. Mass storage 407 can be used to store information and instructions. For example, hard disks such as the Adaptec® family of SCSI drives, an optical disc, an array of disks such as RAID, such as the Adaptec family of RAID drives, or any other mass storage devices may be used.

Bus 401 communicatively couples processor(s) 402 with the other memory, storage and communication blocks. Bus 401 can be a PCI /PCI-X, SCSI, or USB based system bus (or other) depending on the storage devices used. Removable storage media 405 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

Embodiments of the present invention include various steps, which will be described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method for determining changes in network topology, the method comprising:
obtaining a copy of a routing database from a router in a network;
deriving current link states from the copy of the routing database according to a routing database format associated with the routing protocol used on the network;
formatting the current link states into a reference format;
comparing the formatted current link states to reference link states to determine differences between the current link states and the reference link states.

2. The method of claim 1, wherein obtaining a copy of the routing database comprises logging in to the router and requesting the routing database from the router.

3. The method of claim 1, wherein obtaining a copy of the routing database comprises requesting the routing database through a management connection to the router.

4. The method of claim 1, wherein obtaining a copy of the routing database comprises receiving the copy of the routing database by a computer that does not participate in the routing protocol.

5. The method of claim 1, further comprising obtaining router interface names identifying router interfaces associated with one or more routers on the network.

6. The method of claim 5, further comprising mapping Internet Protocol addresses of router interfaces in the routing database with associated ones of the router interface names.

7. The method of claim 6, further comprising presenting the determined link state differences in a user-friendly presentation including the router interface names.

8. The method of claim 1, wherein the reference link states are prior network link states.

9. The method of claim 1, further comprising updating the reference link states based on the determined link state differences.

10. The method of claim 1, further comprising receiving input from a user indicating one or more link state changes that are permanent.

11. A system for determining changes in a network topology, the system comprising:
a link state capture module configured to obtain a copy of a routing database from a connected router;
a link state derivation module configured to derive current link states from the copy of the routing database according to a routing protocol database format associated with a routing protocol used by the router;
a formatting module configured to format the derived current link states into a reference format;
a comparing module configured to compare the current link states to reference link states to determine one or more link state differences.

12. The system of claim 11, further comprising a names determination module configured to obtain router interface names and map the router names to IP addresses in the link state differences.

13. The system of claim 11, wherein the link state capture module obtains a copy of the routing database by logging in to the network router via a management connection to the network router.

14. The system of claim 11, wherein the link state capture module does not participate in the routing protocol with the network router.

15. The system of claim 12, further comprising an output module configured to present the link state differences in a user-friendly presentation including the mapped router interface names.

16. The system of claim 15, wherein the user-friendly presentation presents link state differences on a link-by-link basis.

17. The system of claim 16, wherein the link-by-link presentation identifies both network routers on either end of a link and both router interfaces on either end of the link.

18. The system of claim 15 wherein the link state differences that are presented include one or more of removed links, added links, removed routers, added routers, changed metrics, changed bandwidth, changed router identifier, and changed color.

19. The system of claim 11, further comprising a reference link state update module configured to use the link state differences to update the reference link states to correspond to the current link states.

20. The system of claim 11, further comprising a reference link state update module configured to update the reference link states with changes that a user selects as permanent.

21. The system of claim 11, wherein the routing protocols include an Open Shortest Path First (OSPF) routing protocol, an OSPF protocol with Traffic Engineering (TE) extensions, and intermediate system to intermediate system (IS-IS) protocol.
